(19) United States
(12) Patent Application Publication
(10) Pub. No.: US 2021/0191188 A1
(43) Pub. Date: Jun. 24, 2021

(54) LIQUID CRYSTAL DISPLAY PANEL

(71) Applicant: TCL China Star Optoelectronics Technology Co., LTD, Shenzhen, Guangdong (CN)

(72) Inventor: Yun YU, Shenzhen, Guangdong (CN)

(21) Appl. No.: 16/627,845

(22) PCT Filed: Dec. 19, 2019
(86) PCT No.: PCT/CN2019/126595

§ 371 Date: Dec. 31, 2019

(51) Int. Cl. G02F 1/1335

(52) U.S. Cl. CPC G02F 1/133512; G02F 1/133514; G02F 1/1368; G02F 2202/28; G02F 1/133528

(57) ABSTRACT

The present invention discloses a liquid crystal display panel including a thin film transistor substrate, a color filter substrate, and an upper polarizer disposed on an outside of the color filter substrate. An orthographic projection of the color filter substrate on the upper polarizer encompasses an orthographic projection of the thin film transistor substrate on the upper polarizer. A light shielding adhesive layer is disposed on a side surface of the color filter substrate and is connected securely to the color filter substrate, the thin film transistor substrate, and the upper polarizer.

### FIELD OF INVENTION

The present invention relates to a field of display technologies, especially relates to a liquid crystal display panel. BACKGROUND OF INVENTION

Bezel Less means a liquid crystal display device without a front bezel. Bezel Less products extremely improves beauty of the liquid crystal display devices to provide customers with more friendly experience. At present, a liquid crystal display device usually includes a thin film transistor (TFT) substrate and a color filter (CF) substrate disposed oppositely, a first polarizer disposed on an outside of the CF substrate, and a second polarizer disposed on an outside of the TFT substrate.

In a conventional liquid crystal display device, a design of a retracted CF substrate is adopted, in other words, an edge portion of the CF substrate is cut. Indentation of the CF substrate forms a gap between an edge portion of the first polarizer and an edge portion of the TFT substrate.

To prevent light leakage on the edge, it is required to coat an adhesive on a side of the liquid crystal display device. However, it is difficult for an adhesive material to be fully filed into the gap between the first polarizer and the TFT substrate during a adhesive coating process, which easily causes serious exterior edge bubbles on the side to affect a quality of the display panel.

### SUMMARY OF INVENTION

### Technical issue

The present invention provides a liquid crystal display panel to solve the technical issue that it is difficult for an adhesive material to be fully filed into the gap between the first polarizer and the TFT substrate during a adhesive coating process, which easily causes serious exterior edge bubbles on the side to affect a quality of the display panel.

### Technical solution

In a first aspect, the present invention provides a liquid crystal display panel, comprising:

a thin film transistor substrate;

a color filter substrate;

a frame sealant and a liquid crystal layer disposed between the color filter substrate and the thin film transistor substrate; and

an upper polarizer disposed on an outside of the color filter substrate;

wherein an orthographic projection of the color filter substrate on the upper polarizer encompasses an orthographic projection of the thin film transistor substrate on the upper polarizer; a light shielding adhesive layer is disposed on a side surface of the color filter substrate and is connected securely to the color filter substrate, the thin film transistor substrate, and the upper polarizer, and the light shielding adhesive layer is disposed around a periphery of the color filter substrate.

In some embodiments, the orthographic projection of the color filter substrate on the upper polarizer coincides with the orthographic projection of the thin film transistor substrate on the upper polarizer.

In some embodiments, the color filter substrate comprises a first main body portion and a first edge portion extending along a direction away from the first main body portion, and an orthographic projection of the first main body portion on the upper polarizer coincides with the orthographic projection of the thin film transistor substrate on the upper polarizer.

In some embodiments, the first edge portion is disposed around a periphery of the first main body portion.

In some embodiments, a length of an extension of the first edge portion along the direction away from the first main body portion is 30-130 microns.

In some embodiments, an orthographic projection of the upper polarizer on the thin film transistor substrate encompasses an orthographic projection of the color filter substrate on the thin film transistor substrate.

In some embodiments, the upper polarizer the orthographic projection of the upper polarizer on the thin film transistor substrate coincides with the orthographic projection of the color filter substrate on the thin film transistor substrate, and the light shielding adhesive layer contacts and is connected to a side surface of the upper polarizer.

In some embodiments, the upper polarizer comprises a second main body portion and a second edge portion extending along a direction away from the second main body portion, an orthographic projection of the second main body portion on the thin film transistor substrate coincides with the orthographic projection of the color filter substrate on the thin film transistor substrate, and the light shielding adhesive layer contacts and is connected to an inner surface of the second edge portion.

In some embodiments, the liquid crystal display panel further comprises a lower polarizer disposed on an outside of the thin film transistor substrate; an orthographic projection of the thin film transistor substrate on the color filter substrate encompasses an orthographic projection of the lower polarizer on the color filter substrate, and an edge of the lower polarizer extends to a position corresponding to the frame sealant.

In some embodiments, a portion of the light shielding adhesive layer is located between the color filter substrate and the thin film transistor substrate.

In a second aspect, the present invention also provides a liquid crystal display panel, comprising:

a thin film transistor substrate;

a color filter substrate;

a frame sealant and a liquid crystal layer disposed between the color filter substrate and the thin film transistor substrate; and

an upper polarizer disposed on an outside of the color filter substrate;

wherein an orthographic projection of the color filter substrate on the upper polarizer encompasses an orthographic projection of the thin film transistor substrate on the upper polarizer; a light shielding adhesive layer is disposed on a side surface of the color filter substrate and is connected securely to the color filter substrate, the thin film transistor substrate, and the upper polarizer.

In some embodiments, the orthographic projection of the color filter substrate on the upper polarizer coincides with the orthographic projection of the thin film transistor substrate on the upper polarizer.

In some embodiments, the color filter substrate comprises a first main body portion and a first edge portion extending along a direction away from the first main body portion, and an orthographic projection of the first main body portion on the upper polarizer coincides with the orthographic projection of the thin film transistor substrate on the upper polarizer.

In some embodiments, the first edge portion is disposed around a periphery of the first main body portion.

In some embodiments, a length of an extension of the first edge portion along the direction away from the first main body portion is 30-130 microns.

In some embodiments, an orthographic projection of the upper polarizer on the thin film transistor substrate encompasses an orthographic projection of the color filter substrate on the thin film transistor substrate.

In some embodiments, the orthographic projection of the upper polarizer on the thin film transistor substrate coincides with the orthographic projection of the color filter substrate on the thin film transistor substrate, and the light shielding adhesive layer contacts and is connected to a side surface of the upper polarizer.

In some embodiments, the upper polarizer comprises a second main body portion and a second edge portion extending along a direction away from the second main body portion, an orthographic projection of the second main body portion on the thin film transistor substrate coincides with the orthographic projection of the color filter substrate on the thin film transistor substrate, and the light shielding adhesive layer contacts and is connected to an inner surface of the second edge portion.

In some embodiments, the liquid crystal display panel further comprises a lower polarizer disposed on an outside of the thin film transistor substrate; an orthographic projection of the thin film transistor substrate on the color filter substrate encompasses an orthographic projection of the lower polarizer on the color filter substrate, and an edge of the lower polarizer extends to a position corresponding to the frame sealant.

In some embodiments, a portion of the light shielding adhesive layer is located between the color filter substrate and the thin film transistor substrate.

Advantages

By optimizing the structure of the edge portion of the color filter substrate, an edge side surface of the color filter substrate is flush with an edge side surface of the thin film transistor substrate, or alternately, a position of the edge portion of the color filter substrate is set to be exposed out of an edge of the thin film transistor substrate. When a light shielding adhesive layer is coated on the side of the color filter substrate after the upper polarizer is attached on the color filter substrate, because no great gap exists between the edge portion of the upper polarizer and the edge portion of the thin film transistor substrate, serious exterior edge bubbles on the light shielding adhesive layer can be effectively prevented to improve the edge quality of the liquid crystal display panel.

### DESCRIPTION OF DRAWINGS

FIG. 1 is a schematic structural view of a liquid crystal display panel in a first embodiment of the present invention;

FIG. 2 is a schematic structural view of a liquid crystal display panel in a second embodiment of the present invention; and

FIG. 3 is a schematic structural view of a liquid crystal display panel in an embodiment of the present invention.

### REFERENCE CHARACTERS

10, color filter substrate; 11, first main body portion; 12, first edge portion; 20, thin film transistor substrate; 30, liquid crystal layer; 40, frame sealant; 50, light shielding adhesive layer; 60, upper polarizer; 61, second main body portion; 62, second edge portion; 70, lower polarizer.

### DETAILED DESCRIPTION OF PREFERRED EMBODIMENTS

The present invention provides a liquid crystal display panel. To make the objective, the technical solution, and the effect of the present invention clearer and more explicit, the present invention will be further described in detail below with reference to the accompanying drawings. It should be understood that the specific embodiments described here are only used to explain the present invention instead of being used to limit the present invention.

The present invention aims at the technical issue that in the conventional liquid crystal display device, it is difficult for an adhesive material to be fully filed into the gap between the first polarizer and the TFT substrate during a adhesive coating process, which easily causes serious exterior edge bubbles on the side to affect a quality of the display panel. The present invention can solve the above issue.

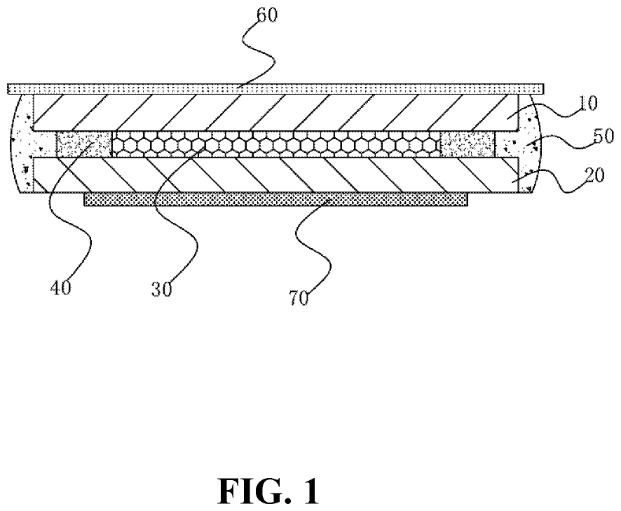

A liquid crystal display panel, with reference to FIG. 1, comprises a thin film transistor substrate 20, a color filter substrate 10, an upper polarizer 60 disposed on an outside of the color filter substrate 10, a lower polarizer 70 disposed on an outside of the thin film transistor substrate 20, and a frame sealant 40 and a liquid crystal layer 30 disposed between the color filter substrate 10 and the thin film transistor substrate 20.

An orthographic projection of the color filter substrate 10 on the upper polarizer 60 encompasses an orthographic projection of the thin film transistor substrate 20 on the upper polarizer 60. A light shielding adhesive layer 50 is disposed on a side surface of the color filter substrate 10 and is connected securely to the color filter substrate 10, the thin film transistor substrate 20, and the upper polarizer 60. The light shielding adhesive layer 50 is disposed around a periphery of the color filter substrate 10.

A design of optimizing an edge portion of the liquid crystal display panel attaches the upper polarizer 60 to color filter substrate 10, and coats the light shielding adhesive layer 50 on color filter substrate 10, because no great gap exists between the edge portion of the upper polarizer 60 and the edge portion of the thin film transistor substrate 20, serious exterior edge bubbles on the light shielding adhesive layer 50 can be effectively prevented to improve the edge quality of the liquid crystal display panel.

In a first embodiment, the orthographic projection of the color filter substrate 10 on the upper polarizer 60 coincides with the orthographic projection of the thin film transistor substrate 20 on the upper polarizer 60.

After the color filter substrate 10 is aligned with and bonded to thin film transistor substrate 20, an edge portion of the color filter substrate 10 is processed by a cutting process such that the side surface of the color filter substrate 10 is flush with a side surface of the thin film transistor substrate 20.

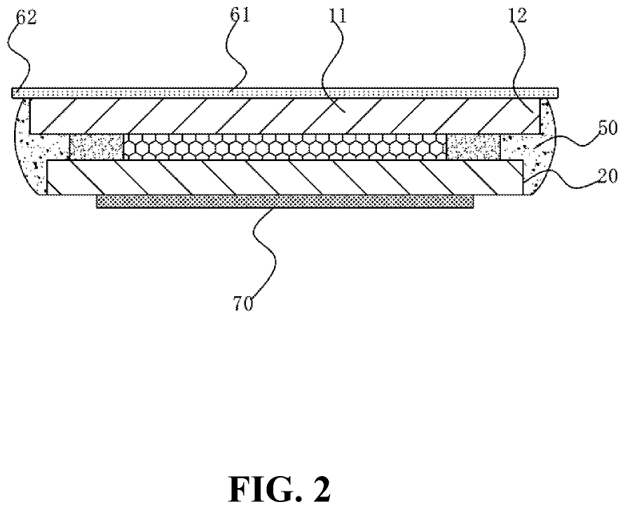

In a second embodiment, with reference to FIG. 2, the color filter substrate 10 comprises a first main body portion 11 and a first edge portion 12 extending along a direction away from the first main body portion 11. An orthographic projection of the first main body portion 11 on the upper polarizer 60 coincides with the orthographic projection of the thin film transistor substrate 20 on the upper polarizer 60.

The first edge portion 12 and the first main body portion 11 are formed integrally to form the color filter substrate 10, and the first edge portion 12 extends outward to expose an edge of the thin film transistor substrate 20 such that no great gap exists between the edge portion of the upper polarizer 60 and edge portion of the thin film transistor substrate 20.

Furthermore, the first edge portion 12 is disposed around a periphery of the first main body portion 11.

Furthermore, a length of an extension of the first edge portion 12 along the direction away from the first main body portion 11 is 30-130 microns.

In an embodiment, the extension of the first edge portion 12 along the direction away from the first main body portion 11 is 50, 80, or 100 microns.

Specifically, an orthographic projection of the upper polarizer 60 on the thin film transistor substrate 20 encompasses an orthographic projection of the color filter substrate 10 on the thin film transistor substrate 20 such that an entire surface of the color filter substrate 10 is covered by the upper polarizer 60, which enhances aesthetic beauty of the edge of the liquid crystal display panel.

In an embodiment, the upper polarizer 60 comprises a second main body portion 61 and a second edge portion 62 extending along a direction away from the second main body portion 61. An orthographic projection of the second main body portion 61 on the thin film transistor substrate 20 coincides with the orthographic projection of the color filter substrate 10 on the thin film transistor substrate 20. The light shielding adhesive layer 50 contacts and is connected to an inner surface of the second edge portion 62.

The second edge portion 62 and the second main body portion 61 are formed integrally to form the upper polarizer 60, and the second edge portion 62 extends outward to expose an edge of the color filter substrate 10.

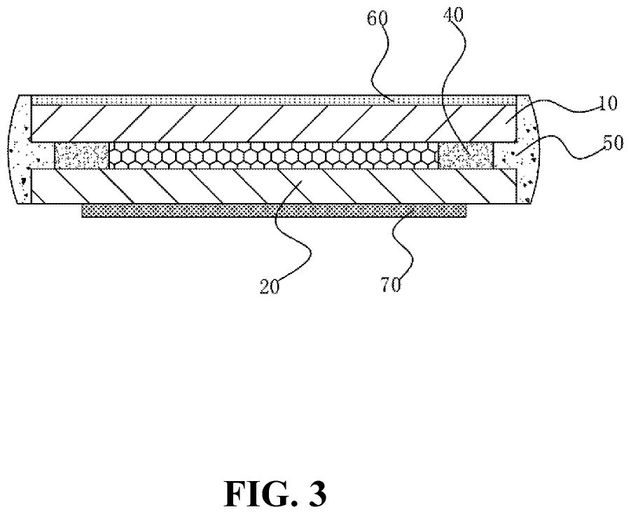

In another embodiment, with reference to FIG. 3, the orthographic projection of the upper polarizer 60 on the thin film transistor substrate 20 coincides with the orthographic projection of the color filter substrate 10 on the thin film transistor substrate 20. The light shielding adhesive layer 50 contacts and is connected to a side surface of the upper polarizer 60.

It should be explained that, with reference to FIG. 3, it is only illustrated that an edge side surface of the upper polarizer 60 , an edge side surface of the color filter substrate 10, and an edge side surface of the thin film transistor substrate 20 n edge side surface are flush with one another. In practical applications, under a circumstance of the edge side surface of the upper polarizer 60 being flush with the edge side surface of the color filter substrate 10, the edge portion of the color filter substrate 10 can be set to be exposed out of the edge of the thin film transistor substrate 20.

Specifically, an orthographic projection of the thin film transistor substrate 20 on the color filter substrate 10 encompasses an orthographic projection of the lower polarizer 70 on the color filter substrate 10, and an edge of the lower polarizer 70 extends to a position corresponding to the frame sealant 40.

Specifically, a portion of the light shielding adhesive layer 50 is located between the color filter substrate 10 and the thin film transistor substrate 20 to enhance a connection strength of the light shielding adhesive layer 50 with the color filter substrate 10 and the thin film transistor substrate 20, and simultaneously performs a better light shielding effect to prevent light leakage on the edge.

Advantages of the present invention are as follows: By optimizing the structure of the edge portion of the color filter substrate 10, an edge side surface of the color filter substrate 10 is flush with an edge side surface of the thin film transistor substrate 20. Alternately, a position of the edge portion of the color filter substrate 10 is set to be exposed out of an edge of the thin film transistor substrate 20 and the upper polarizer 60 is attached on the color filter substrate 10, and when a light shielding adhesive layer 50 is coated on the side of the color filter substrate 10, because no great gap exists between the edge portion of the upper polarizer 60 and the edge portion of the thin film transistor substrate 20, serious exterior edge bubbles on the light shielding adhesive layer 50 are effectively prevented to improve edge quality of the liquid crystal display panel.

It can be understood that for a person of ordinary skill in the art, equivalent replacements or changes can be made according to the technical solution of the present invention and its inventive concept, and all these changes or replacements should belong to the scope of protection of the appended claims of the present invention.

1. A liquid crystal display panel, comprising:
a thin film transistor substrate;
a color filter substrate;
a frame sealant and a liquid crystal layer disposed between the color filter substrate and the thin film transistor substrate; and
an upper polarizer disposed on an outside of the color filter substrate;
wherein an orthographic projection of the color filter substrate on the upper polarizer encompasses an orthographic projection of the thin film transistor substrate on the upper polarizer; a light shielding adhesive layer is disposed on a side surface of the color filter substrate and is connected securely to the color filter substrate, the thin film transistor substrate, and the upper polarizer, and the light shielding adhesive layer is disposed around a periphery of the color filter substrate;
wherein an interval is defined between the color filter substrate and the thin film transistor substrate, and a portion of the light shielding adhesive layer inwardly extends in the interval and contacts inner surfaces of the color filter substrate and the thin film transistor substrate.

2. The liquid crystal display panel as claimed in claim 1, wherein the orthographic projection of the color filter substrate on the upper polarizer coincides with the orthographic projection of the thin film transistor substrate on the upper polarizer.

3. The liquid crystal display panel as claimed in claim 1, wherein the color filter substrate comprises a first main body portion and a first edge portion extending along a direction away from the first main body portion, and an orthographic projection of the first main body portion on the upper polarizer coincides with the orthographic projection of the thin film transistor substrate on the upper polarizer.

4. The liquid crystal display panel as claimed in claim 3, wherein the first edge portion is disposed around a periphery of the first main body portion.

5. The liquid crystal display panel as claimed in claim 3, wherein a length of an extension of the first edge portion along the direction away from the first main body portion is 30-130 microns.

6. The liquid crystal display panel as claimed in claim 1, wherein an orthographic projection of the upper polarizer on a projection plane corresponding to the thin film transistor substrate encompasses an orthographic projection of the color filter substrate on the thin film transistor substrate.

7. The liquid crystal display panel as claimed in claim 6, wherein the orthographic projection of the upper polarizer on the projection plane corresponding to the thin film transistor substrate coincides with the orthographic projection of the color filter substrate on the thin film transistor substrate, and the light shielding adhesive layer contacts and is connected to a side surface of the upper polarizer.

8. The liquid crystal display panel as claimed in claim 6, wherein the upper polarizer comprises a second main body portion and a second edge portion extending along a direction away from the second main body portion, an orthographic projection of the second main body portion on the thin film transistor substrate coincides with the orthographic projection of the color filter substrate on the thin film transistor substrate, and the light shielding adhesive layer contacts and is connected to an inner surface of the second edge portion.

9. The liquid crystal display panel as claimed in claim 1, wherein the liquid crystal display panel further comprises a lower polarizer disposed on an outside of the thin film transistor substrate; an orthographic projection of the thin film transistor substrate on the color filter substrate encompasses an orthographic projection of the lower polarizer on the color filter substrate, and an edge of the lower polarizer extends to a position corresponding to the frame sealant.

10. (canceled)

11. A liquid crystal display panel, comprising:
a thin film transistor substrate;
a color filter substrate;
a frame sealant and a liquid crystal layer disposed between the color filter substrate and the thin film transistor substrate; and
an upper polarizer disposed on an outside of the color filter substrate;
wherein an orthographic projection of the color filter substrate on the upper polarizer encompasses an orthographic projection of the thin film transistor substrate on the upper polarizer; a light shielding adhesive layer is disposed on a side surface of the color filter substrate and is connected securely to the color filter substrate, the thin film transistor substrate, and the upper polarizer;
wherein an interval is defined between the color filter substrate and the thin film transistor substrate, and a portion of the light shielding adhesive layer inwardly extends in the interval and contacts inner surfaces of the color filter substrate and the thin film transistor substrate.

12. The liquid crystal display panel as claimed in claim 11, wherein the orthographic projection of the color filter substrate on the upper polarizer coincides with the orthographic projection of the thin film transistor substrate on the upper polarizer.

13. The liquid crystal display panel as claimed in claim 11, wherein the color filter substrate comprises a first main body portion and a first edge portion extending along a direction away from the first main body portion, and an orthographic projection of the first main body portion on the upper polarizer coincides with the orthographic projection of the thin film transistor substrate on the upper polarizer.

14. The liquid crystal display panel as claimed in claim 13, wherein the first edge portion is disposed around a periphery of the first main body portion.

15. The liquid crystal display panel as claimed in claim 13, wherein a length of an extension of the first edge portion along the direction away from the first main body portion is 30-130 microns.

16. The liquid crystal display panel as claimed in claim 11, wherein an orthographic projection of the upper polarizer on a projection plane corresponding to the thin film transistor substrate encompasses an orthographic projection of the color filter substrate on the thin film transistor substrate.

17. The liquid crystal display panel as claimed in claim 16, wherein the orthographic projection of the upper polarizer on the projection plane corresponding to the thin film transistor substrate coincides with the orthographic projection of the color filter substrate on the thin film transistor substrate, and the light shielding adhesive layer contacts and is connected to a side surface of the upper polarizer.

18. The liquid crystal display panel as claimed in claim 16, wherein the upper polarizer comprises a second main body portion and a second edge portion extending along a direction away from the second main body portion, an orthographic projection of the second main body portion on the thin film transistor substrate coincides with the orthographic projection of the color filter substrate on the thin film transistor substrate, and the light shielding adhesive layer contacts and is connected to an inner surface of the second edge portion.

19. The liquid crystal display panel as claimed in claim 11, wherein the liquid crystal display panel further comprises a lower polarizer disposed on an outside of the thin film transistor substrate; an orthographic projection of the thin film transistor substrate on the color filter substrate encompasses an orthographic projection of the lower polarizer on the color filter substrate, and an edge of the lower polarizer extends to a position corresponding to the frame sealant.

20. (canceled)
